(19) United States
(12) Patent Application Publication
(10) Pub. No.: US 2016/0104554 A1
(43) Pub. Date: Apr. 14, 2016

(54) FUNCTIONALIZED POROUS POLYMER NANOCOMPOSITES

(71) Applicant: Washington State University, Pullman, WA (US)

(72) Inventors: Wei-hong Zhong, Pullman, WA (US); Yu Wang, Pullman, WA (US); Bin Li, Wichita, KS (US)

(21) Appl. No.: 14/877,635

(22) Filed: Oct. 7, 2015

Related U.S. Application Data
(60) Provisional application No. 62/062,035, filed on Oct. 9, 2014.

(51) Int. Cl. H01B 1/24; C08J 9/00; B29C 39/14; C08J 9/28

(52) U.S. Cl. CPC H01B 1/24; C08J 9/283; C08J 9/008; C08J 9/0061; B29C 39/14; C08J 2369/00; C08J 2201/0504; C08J 2201/0502; C08J 2325/18; C08J 2365/00; B29K 2069/00

(57) ABSTRACT

Porous polymer nanocomposites with controllable distribution/dispersion of components are provided. These nanocomposites are useful for various applications, such as flexible 3D electrodes for batteries, flexible sensors and conductors and the like. Also provided are emulsion compositions and methods for preparing the porous polymer nanocomposites.

### CROSS-REFERENCE TO RELATED APPLICATION

The present application claims priority to U.S. Provisional Application No. 62/062,035, filed on Oct. 9, 2014, the entire contents of which are herein incorporated by reference.

### BACKGROUND

Functional porous polymer films are of great interest to academia as well as industry for a variety of applications, such as gas separation, water purification and sensors. A porous structure can not only reduce the density of the material, but can also increase the surface/interface area. There are several ways to fabricate porous films, such as the self-assembly of water droplets known as the ‘breath figure’ (BF) technique, water/oil emulsion technology, and stretching techniques. These techniques have been focused on the control of the pore structures (the size, for example).

### SUMMARY

This technology relates to the development of porous polymer nanocomposite materials with designed functionalizations through an effective and facile approach for broad applications, such as in electronics, energy, and environment.

Briefly, in accordance with one aspect, a porous polymer nanocomposite material is provided. The porous polymer nanocomposite material comprises nanoparticles and a polymer matrix comprising pores, wherein at least about 10% of the nanoparticles (NPs) are on the surface of the pores.

In accordance with another aspect, an emulsion composition is provided. The emulsion composition comprises a first phase and a second phase forming the emulsion. The first phase comprises a suspension of nanoparticles in a first solvent. The second phase comprises a polymer solution in a second solvent. The first solvent and the second solvent are not miscible in each other. The emulsion composition is used in preparing a porous polymer nanocomposite material described herein.

In accordance with another aspect, a method of preparing a porous polymer nanocomposite material is provided. The method comprises preparing an emulsion composition comprising a first phase and a second phase by mixing the first phase with the second phase. The first phase comprises a suspension of nanoparticles in a first solvent. The second phase comprises a polymer solution in a second solvent. The first solvent and the second solvent are not miscible. The emulsion composition is then cast on a substrate to form a film. The film is dried to form the porous polymer nanocomposite material.

The foregoing summary is illustrative only and is not intended to be in any way limiting. In addition to the illustrative aspects, embodiments, and features described above, further aspects, embodiments, and features will become apparent by reference to the drawings and the following detailed description.

These and other aspects are described in more details in the text that follows.

### BRIEF DESCRIPTION OF THE FIGURES

FIG. 1 illustrates an example of a procedure according to the present technology for the preparation of a porous polymeric nanocomposite material with controllable nanoparticle dispersion/distribution.

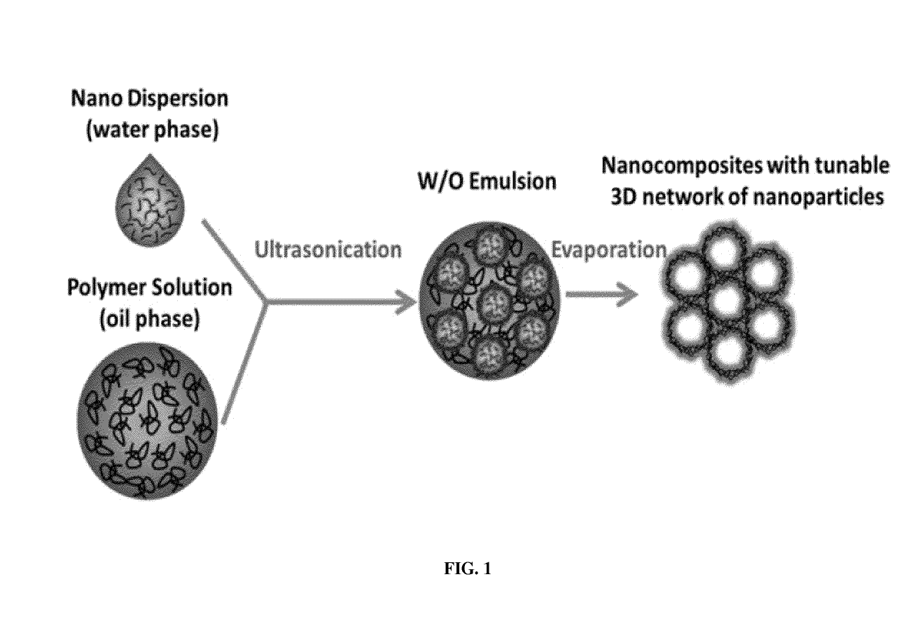

FIG. 2(a) illustrates an example of a preparation of a porous nanocomposite material by an emulsion comprising two phases, a polymer solution and a nanoparticle (NP) suspension. FIG. 2(b) illustrates a schematic of the compositions/structures of the emulsion. FIG. 2(c) is a digital photo of a porous nanocomposite film after drying. FIGS. 2(d) and 2(e) are scanning electron microscopy (SEM) images of the surface (contacted with the substrate) and fracture surface of the porous film, respectively. Scale bars: 2(d) 100 μm, 2(e) 10 μm. FIG. 2(f) is a schematic illustration of the controlled distribution of NPs.

FIG. 3(a) illustrates carbon nanotube (CNT) loading dependent behavior of the electrical properties of the porous film (the cartoon shows the mechanism for the formation of the conduction percolation). FIG. 3(b) is an optical image for the conductive network constructed by the porous structures. FIG. 3(c) are SEM images showing the distribution of NP on the surface of the pores.

FIGS. 4(a)-4(e) are SEM images of an example of the fracture surface showing the pore structures with increasing loading of NPs (a fixed water/oil (W/O) ratio of 0.15 was used for all the concentrations, scale bars: 50 μm). FIG. 4(f) is an example of a plot of the diameter of the pores as a function of NPs loading.

FIGS. 5(a)-5(d) illustrate the control of the distribution of NPs (pore structures) by varying the W/O volume ratio (the overall loading of NPs is 2 weight percent (wt %)) as revealed by optical images: (a) 0.05, (b) 0.15, (c) 0.2 and (d) 0.3 (scale bars: 20 μm). FIG. 5(e) is a schematic of the effects of W/O ratio on the distribution of NPs. FIG. 5(f) is a plot of the distribution state dependent behavior of the electric conductivity.

FIGS. 6(a)-6(d) are optical images of an example of porous film with controlled distribution of NPs. (a) 5×, (b) 20×, (c) 50× and (d) 100×.

FIGS. 7(a)-7(c) illustrate the distribution of NPs (MWCNTs) on the pores for samples with different loading: (a) 1 wt % (b) 2 wt % and (c) 3 wt %. NPs are found on the surface of the pores as shown by the SEM images with high magnification.

FIG. 8 illustrates the Effects of the film thickness on the pore size for the sample with 2 wt % of multi-wall carbon nanotube (MWCNT) and a W/O ratio of 0.15. The inserts are the SEM images of the fracture surface of the porous films. Scale bars: 20 μm.

FIG. 9(a)-9(d) are SEM images of the fracture surface for the samples with W/O ratio of 0.1, 0.15, 0.2 and 0.3, respectively, showing the W/O ratio dependent behavior of the pore size for an example of porous nanocomposites with 2 wt % of MWCNTs. FIG. 9(e) shows the average size of the pores as a function of the W/O ratio.

FIGS. 10(a)-10(d) are optical images of the samples with W/O volume ratio of 0.1, 0.15, 0.2 and 0.3, respectively. FIG. 10(e)-10(h) are SEM images of the surface contacting with the glass substrate for the samples with W/O volume ratio of 0.1, 0.15, 0.2 and 0.3, respectively.

FIGS. 11(a)-11(f) demonstrate a D²-PNC film prepared by an embodiment of the developed emulsion technology: FIG. 11(a) Digital photo of a D²-PNC film with 28 wt % loading of CNTs; FIG. 11(b) Schematic of the structures; FIGS. 11(c), (d), (e) and (f) are SEM images of the back surface contacting with the glass substrate, fracture surface of the porous part, fracture surface of the non-porous part (composite current collector) and free surface contacting with air, respectively. The D²-PNCs show gradient structures from porous to non-porous in FIG. 11(b) and FIGS. 11(c)-(f)). The gradient structures could be very attractive for electrodes application since they combine a 3D-porous structure on one side with a non-porous layer on the other side. The 3D-porous structure can be used as active part for application, while the non-porous layer can be directly employed as a composite current collector. This configuration formed in a self-assembled way can remarkably improve the interface/contact between the porous part with electrode function and the non-porous part with current collector function.

FIGS. 12(a)-12(c) are SEM images of the contact surface (with the substrate side) for a porous D2-PNC film (PC/CNT film, CNT: 2 wt %). FIG (b) and FIG (c) show the magnification of a pore.

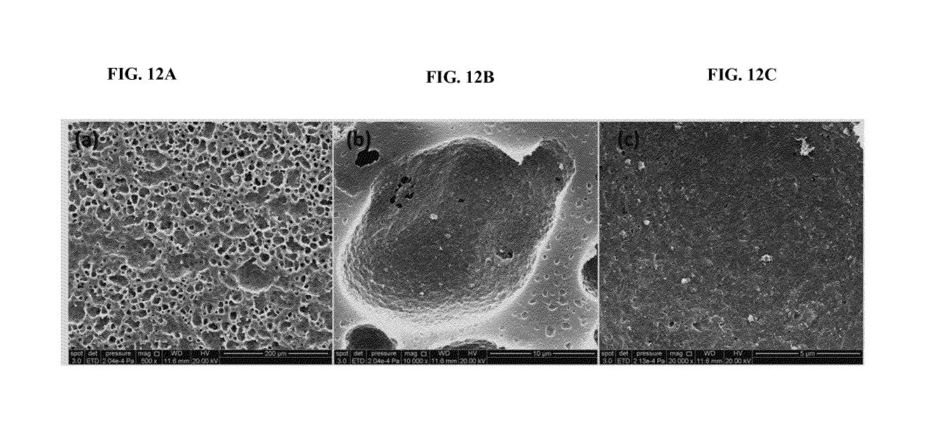

FIGS. 13(a)-13(c) are SEM images of the contact surface (with the substrate side) for a porous D2-PNC film (PC/CNF film, the loading of CNF is 4 wt %)

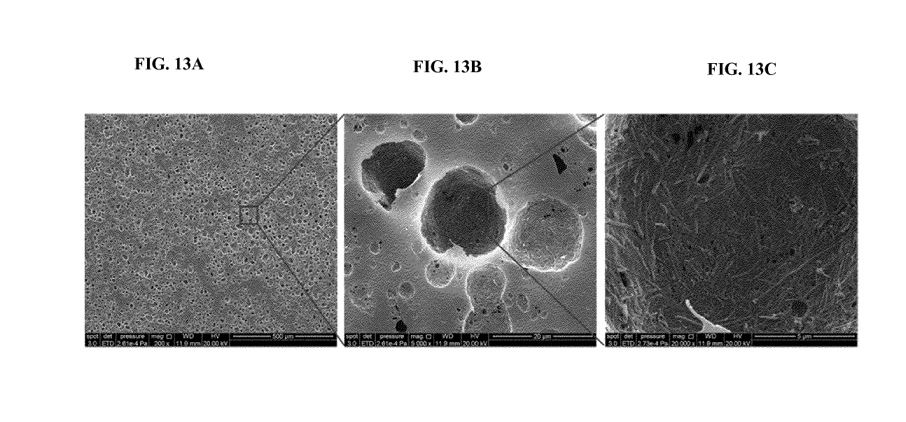

FIGS. 14(a)-14(c) are SEM images of the fracture surface of the porous D²-PNC film (PC/CNF) with different magnifications: FIG. 14(a) 2,500×, FIG. 14(b) 10,000× and FIG. 14(c) 20,000× (CNF: 4 wt %)

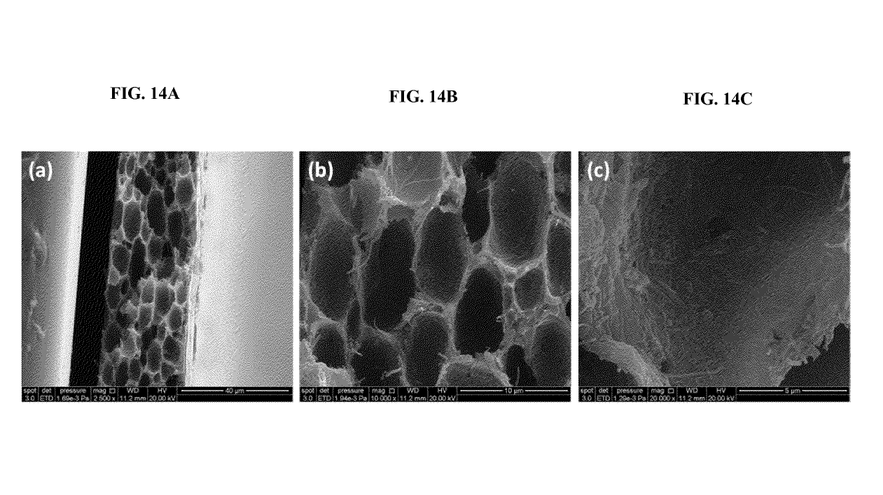

FIGS. 15(a)-15(c) are SEM images of the fracture surface of a D²-PNC film with a high loading of anode particles (graphite) at different magnifications: FIG. 15(a) 2,000×, FIG. 15(b) 10,000× and FIG. 15(c) 20,000× (graphite loading: 50 wt %).

FIGS. 16(a)-16(c) are SEM images of the fracture surface of a D²-PNC film with a high loading of hybrid NPs (graphite and carbon black) at different magnifications: FIG. 16(a) 2,000×, FIG. 16(b) 10,000× and FIG. 16(c) 20,000× (overall loading: 50 wt %, graphite 42 wt %, carbon black 8 wt %).

FIGS. 17(a) and 17(b) demonstrate the flame-retardant behavior of a D²-PNC film with ca. 28 wt % CNTs. FIGS. 17(c)-17(e) present snapshots of the contact angle during different time (eg. liquid electrolyte, lithium perchlorate in propylene carbonate, 1 mol/L) for a droplet on the back surface of D²-PNC (porous side).

FIG. 18 illustrates a flow chart of the preparation for porous D²-PNC film based on emulsion technology: 1 is the traditional compositions for the emulsion system and, 2 is the functionalized compositions presented in some embodiments of this disclosure

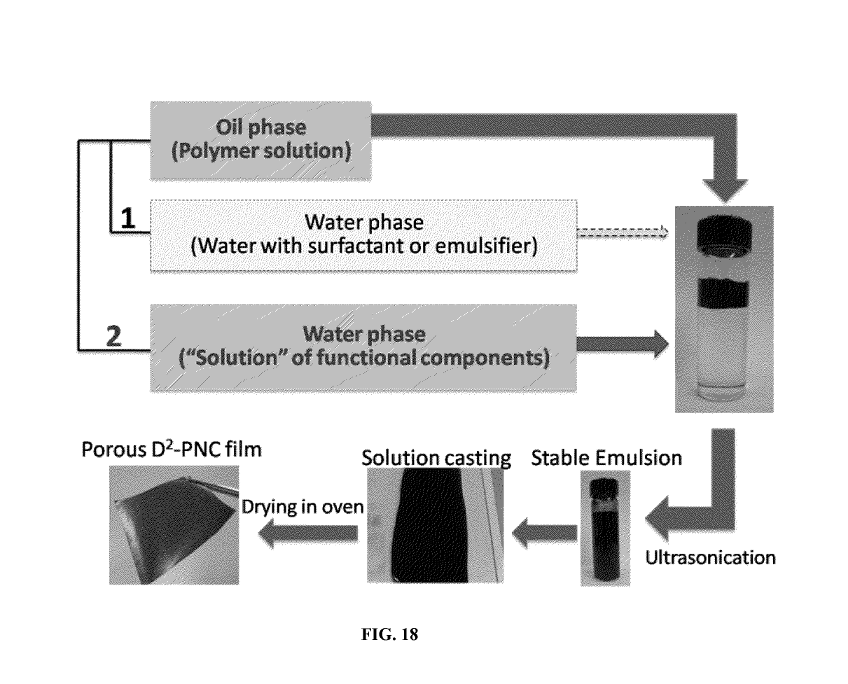

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

It will also be understood that any compound, material or substance which is expressly or implicitly disclosed in the specification and/or recited in a claim as belonging to a group or structurally, compositionally and/or functionally related compounds, materials or substances, includes individual representatives of the group and all combinations thereof. While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% or up to plus or minus 5% of the stated value.

Dispersion and distribution of nanoparticles in nanocomposites as well as the interfaces between NPs and polymer matrix are important factors controlling the final properties of nanocomposites, such as dispersion and distribution controlled porous nanocomposites (D²-PNC). A controlled distribution of NPs will provide nanocomposites with unique properties, such as anisotropic conductivity, high electrical conductivity but low thermal conductivity for thermoelectric materials, high electrical conductivity and elasticity with low density, or adsorption and catalytic properties. Unlike methods for improving dispersion of NPs, control of distribution usually requires special manipulation of the interaction between NPs and polymer matrix as well as the desired fabrication techniques. There are several strategies reported on control of distribution of NPs in nanocomposites, such as the copolymer approach, selective distribution of NPs in polymer blends such as interpenetrating polymer network (IPN) structure, and excluded-volume effects.

Due to the unique morphological structures formed by the self-assembly of copolymers, the distribution of NPs has been successfully controlled in copolymer nanocomposites. In order to “entrap” the NPs, the NPs are usually modified by structure-directing agents, which can preferentially interact with one of the blocks of the copolymer. Accompanying the micro-phase separation of the block copolymer, the NPs are distributed in one of the phases of the copolymer nanocomposites. Selective distribution of NPs in polymer blends provides another way to control the distribution of NPs. For example, Yang and Liu et. al. found that carbon black can preferentially distribute in high density polyethylene (HDPE) when introduced into a HDPE/isotatic polypropylene (iPP) blend. By manipulating the phase structures of the blend, the distribution of NPs can be easily controlled. Similarly, distribution of NPs can also be controlled in blends with interpenetrating polymer networks (IPN) structure. In these efforts, the precursor of NPs (such as the ions of metal particles) were introduced into the IPN system and only interacted with one of the networks, which has the functional groups acting as a transient anchoring agent. After the precursor was reduced by reduction agent, metal nanoparticles were formed in situ and distributed in one of the networks or at the interface. Recently, excluded volume effects have also been employed to prepare nanocomposites with a controlled distribution of NPs. Aqueous polymer emulsion or polymeric particles (ultra-high molecular weight polyethylene, for instance) were used as particles or cells creating excluded volume, which localize the NPs at the interstitial space between polymer particles. Similarly, supercritical CO₂ has been introduced into nanofiller/PP composites to create excluded volume effects (the gas acts as the cell) and prepared nanocomposites with controllable distribution of nanofillers.

In aspects of the present technology, in a two-phase emulsion system (e.g., water/oil emulsion), the design of the compositions in the first phase (e.g., the water phase) or the second phase (e.g., the oil phase) enables the fabrication of new multi-functional nanocomposites with various nanofillers or active materials, such as porous composite electrodes. One advantage for porous polymer nanocomposites is that one can obtain the desired material functions by designing the compositions in the first or second phase, such as by choosing an appropriate polymer solution as the oil phase, and an aqueous nanoparticle “solution” as the water phase. For example, high performance (low percolation level for conduction) conductive polymer composites can be obtained in porous polymer nanocomposites by design of a network-like distribution and a good quality of dispersion of conductive nanoparticles in the nanocomposites.

Provided herein is a tunable 3D network of nanoparticles in segregated nanocomposites prepared via an emulsion process. By individual design of the compositions of the water or oil phase in an emulsion system, the distribution and dispersion of nanoparticles in the resulting nanocomposites can be well controlled. The design flexibility for the compositions of the emulsion system combined with the simplicity of the fabrication of the nanocomposites enables the manipulability of the structures and functions, which is significant for development of advanced functional nanocomposites.

Porous Polymer Nanocomposite Material

Briefly, in accordance with one aspect, a porous polymer nanocomposite material in which the pores are functionalized is provided. The porous polymer nanocomposite material comprises nanoparticles and a polymer matrix comprising pores. In the nanocomposite material, at least about 10%, at least about 20%, at least about 30%, at least about 40%, at least about 50%, at least about 60%, at least about 70%, or about 80%, or any range between any two of the values (end points inclusive) of the nanoparticles are on the surface of the pores and functionalize the pores. In some aspects, no more than about 90%, no more than about 80%, no more than about 70%, no more than about 60%, no more than about 50%, no more than about 40%, no more than about 30%, or about 20%, or any range between two of the values (end points inclusive) of the nanoparticles are distributed inside the polymer matrix, i.e., surrounded by polymer molecules, and not on the surface of the pores.

The porous polymer nanocomposite material can comprise a variety of nanoparticles and polymer matrix. The selection of nanoparticles can depend on the specific application or the specific functionality designed for the nanocomposites. The material may have one type or a combination of different types of nanoparticles. Examples of nanoparticles include, but are not limited to, conductive nanoparticles (e.g., carbon nanotubes (such as multi-wall carbon nanotubes (MWCNTs) and/or single-wall carbon nanotubes), carbon nanofibers, and metal nanoparticles); magnetic nanoparticles (e.g., Fe₃O₄ nanoparticles); catalytic nanoparticles (e.g., RuO₂ and MnO₂ nanoparticles); electrode nanoparticles (silicon, sulfur, carbon nanotubes, and graphene nanoparticles, etc.); sensor particles (e.g., CuO and MoS₂ nanoparticles) and so on.

The polymer that can be used in these applications include, but are not limited to, polycarbonate, polyetherimide, polybutadiene, or a mixture thereof.

The size of the nanoparticles can vary. In some aspects, the size (e.g. average or median size as measured by a length (e.g., the longest or the shortest length)) of the nanoparticles is from about 1 nm to about 100 μm. In some aspects, the size of the nanoparticles of the particles is from about 5 nm to about 50 μm, or to about 10 μm, or to about 5 μm, or to about 1 μm, or to about 500 nm, or to about 200 nm, or from about 10 nm to about 50 μm, or to about 10 μm, or to about 5 μm, or to about 1 μm, or to about 500 nm, or to about 200 nm. Specific examples of sizes include about 1 nm, about 5 nm, about 10 nm, about 15 nm, about 20 nm, about 50 nm, about 100 nm, about 200 nm, about 500 nm, about 1 μm, about 5 μm, about 10 μm, about 50 μm, about 100 μm, and ranges between any two of these values (including endpoints).

In some aspects, the size (e.g., average or median size as measured by a diameter, e.g., the longest or shortest diameter) of the pores is from about 100 nm to about 100 μm. In some aspects, the size of the pores is from about 500 nm to about 50 μm, or from about 1 μm to about 50 μm, or to about 40 μm, or to about 30 μm, or to about 20 μm, or to about 10 μm, or is from about 10 μm to about 100 μm, or to about 50 μm, or to about 40 μm, or to about 30 μm, or to about 20 μm. Specific examples of sizes include about 1 μm, about 5 μm, about 10 μm, about 20 μm, about 30 μm, about 40 μm, about 50 μm, about 60 μm, about 70 μm, about 80 μm, about 90 μm, and about 100 μm, and ranges between any two of these values (including endpoints).

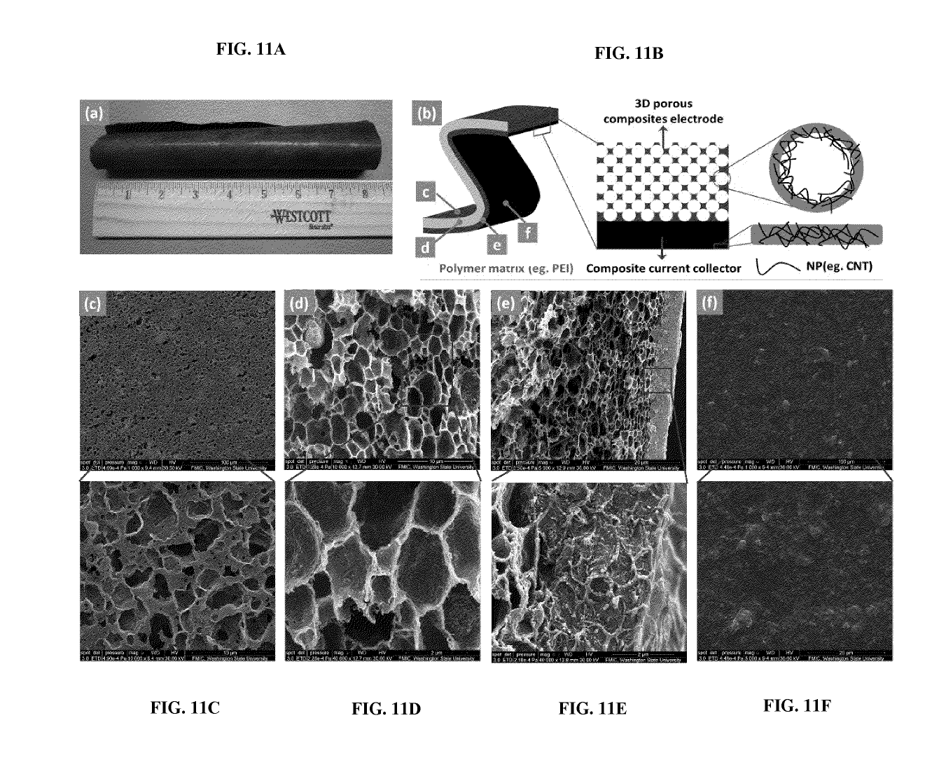

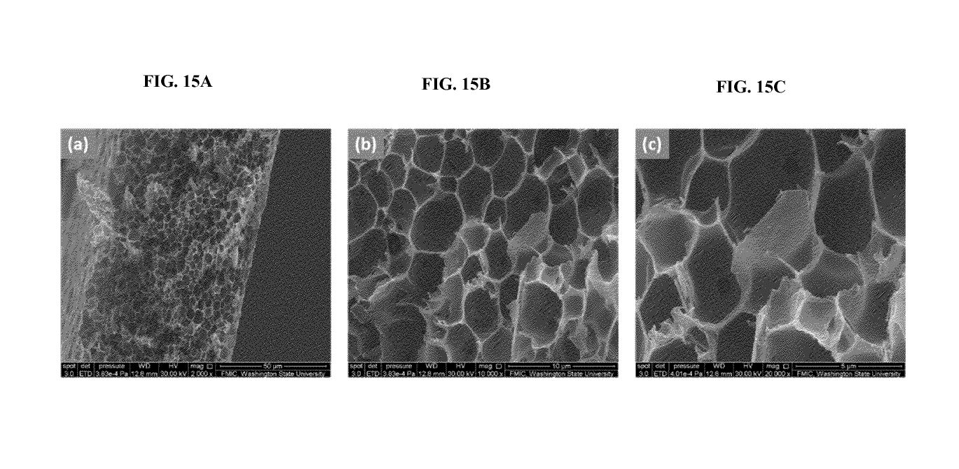

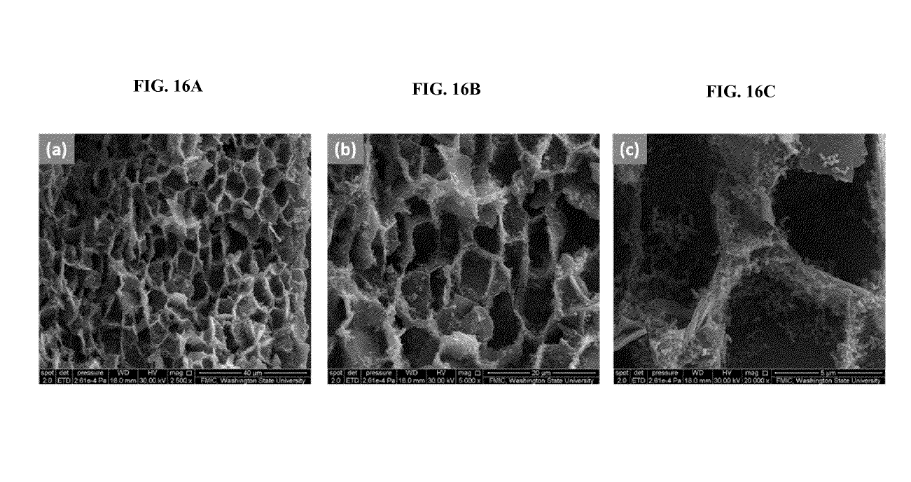

In some aspects, the size (e.g., average or median size as measured by a diameter, e.g., the longest or shortest diameter) of the pores varies through the material, e.g., the pore size shows a gradient from porous to non-porous across a direction of the material. In some embodiments, the material contains a 3D-porous structure having pores of the dimensions listed in herein on one face of the material and a non-porous structure on the opposing face of the material. An exemplary embodiment of this is contained in FIGS. 11(a)-11(f). In one embodiment, the gradient structures are a file, and/or are suitable for use as an electrode. Some embodiments include energy storage devices were D²-PNC films, such as those exemplified in FIGS. 11(a)-11(f) are functionalized as a 3D electrode integrated with composite current collector. For example, by using electrochemically active nanoparticles (NPs), such as carbon NPs (CNT, CNF, graphite and graphene), which may be used as the anode materials for lithium-ion batteries, one can obtain porous D²-PNC films with NPs concentrated at the pore surface. The resulting structure constitutes a powerful 3D porous anode that can be used, e.g., in a battery or capacitor. In another embodiment, active materials with a high loading are introduced into the D²-PNC film. FIGS. 15(a)-15(c) show an embodiment where the porous structures of a D²-PNC film with 50 wt % of graphite. One can find that the porous structures are well controlled with even such high loading of NPs. Further demonstrated in FIGS. 16(a)-16(c) is an embodiment with hybrid conductive fillers for the D²-PNC film. By using hybrid NPs, the structures of the cell (pore) can be further decorated by various nanomaterials or active materials. FIGS. 15(a)-15(c) show the decoration of the cell wall with conductive carbon black. These results indicate a great flexibility in the design of structures and properties/functions of the cells for a specific application.

In some aspects, the material is a film. In some aspects, the film has a thickness of from about 1 μm to about 10 mm. In some aspects, the thickness of the film is from about 1 μm to about 10 mm, to about 5 mm, to about 1 mm, to about 500 μm, or to about 100 μm, or to about 50 μm, or to about 20 μm, or to about 10 μm, or is from about 1 μm, about 50 μm, about 100 μm, about 500 μm, about 1 mm, or about 5 mm to about 10 mm. Specific examples of thicknesses include about 1 μm, about 5 μm, about 10 μm, about 50 μm, about 100 μm, about 500 μm, about 1 mm, about 2 mm, about 5 mm and about 10 mm, and ranges between any two of these values (including endpoints).

The amount of the nanoparticles in the polymer matrix may vary based on many factors, such as the particular desired application and properties of the material and the types of the nanoparticles and the polymer matrix. In some aspects, the amount of nanoparticles in the polymer matrix is from about 0.01 wt % to about 90 wt % of the weight of the material. In some aspects, the amount of nanoparticles in the polymer matrix is about 0.01 wt %, about 0.05 wt %, about 0.1 wt %, about 0.2 wt %, about 0.5 wt %, about 1 wt %, about 2 wt %, about 5 wt %, about 10 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, or is within any range between any two of the values (end points inclusive) of the weight of the material.

In some aspects, the porous polymer nanocomposite material does not comprise one or more of a transient anchoring agent, precursors of nanoparticles which can form nanoparticles in situ, monomers which can polymerize in situ or polymeric particles, such as ultra-high molecular weight polyethylene polymeric particles, or a structure-directing agent, such as those described in Orilall M C, et al., Block copolymer based composition and morphology control in nanostructured hybrid materials for energy conversion and storage: solar cells, batteries, and fuel cells, Chemical Society reviews. 2011; 40(2):520-35, which is incorporated by reference in its entirety. In some aspects, the porous polymer nanocomposite material does not comprise a cross-linked hydrogel.

Porous Polymer Nanocomposite Materials for Energy Storage Applications

In one aspect, the porous polymer nanocomposite materials are electrical conductive materials in which the pores are functionalized by electrode particles, such as silicon, sulfur, carbon nanotubes (e.g., multi-wall carbon nanotubes and/or single-wall carbon nanotubes), carbon nanofibers, metal nanoparticles, graphite, carbon black and/or graphene. In some embodiments, the porous polymer contains one nanocomposite material. In another embodiment, the porous polymer contains two nanocomposite materials. When two nanocomposite materials are provided, the ratio between the two materials may be 99:1 to 1:99 by weight, or 10:90, 20:80, 30:70, 40:60, 50:50, 60:40, 70:30, 80:20, 90:10, or is within any range between any two of the values (end points inclusive) of the weight ratio of the materials.

The conductive porous polymer nanocomposite material may further comprise a conductive polymer. Conductive polymers refer to organic polymers that conduct electricity. These compounds can either have metallic conductivity or can be semiconductors. Conductive polymers include, but are not limited to, linear-backbone “polymer blacks” (such as polyacetylene, polypyrrole, and polyaniline), and their copolymers. Some conductive polymers comprise aromatic rings or double bonds in the polymer chain to provide conductivity. Examples of such polymers include non-heteroatom containing polymers, such as poly(fluorene)s, polyphenylenes, polypyrenes, polyazulenes, polynaphthalenes, poly(acetylene)s (PAC) and poly(p-phenylene vinylene) (PPV); nitrogen-containing polymers, such as poly(pyrrole)s (PPY), polycarbazoles, polyindoles, polyazepines, and polyanilines (PANI); and sulfur-containing polymers, such as poly(thiophene)s (PT), poly(3,4-ethylenedioxythiophene) (PEDOT), and poly(p-phenylene sulfide) (PPS). In some aspects, at least about 10%, at least about 20%, at least about 30%, at least about 40%, at least about 50%, at least about 60%, at least about 70%, or about 80%, or any range between two of the values (end points inclusive) of the conductive polymer is on the surface of the pores and functionalize the pores together with the nanoparticles in the material.

Such materials can be used in electrodes for energy storage applications, such as batteries (lithium/sodium ion batteries, for example) and supercapacitors.

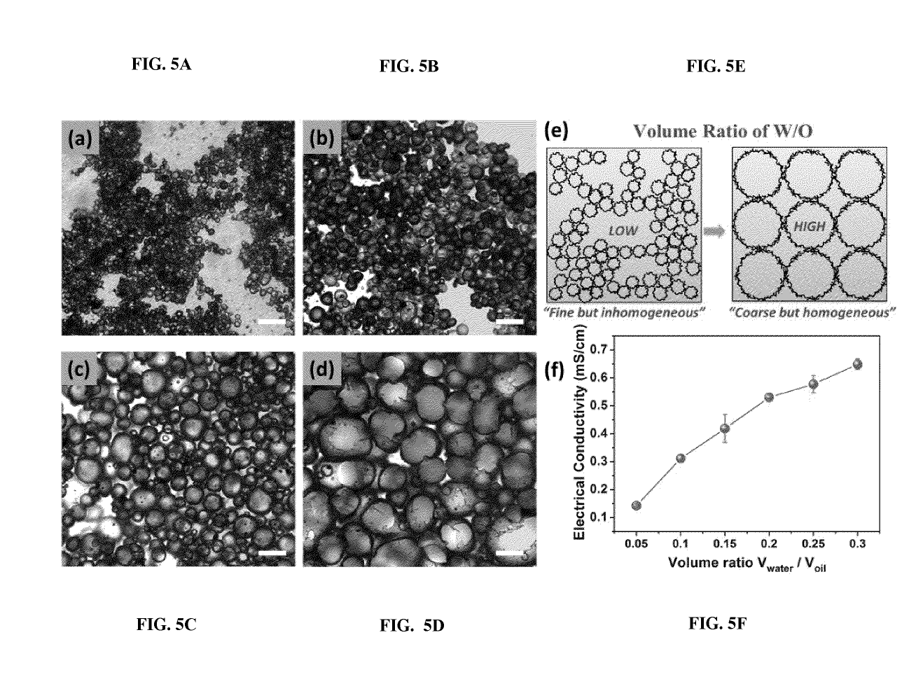

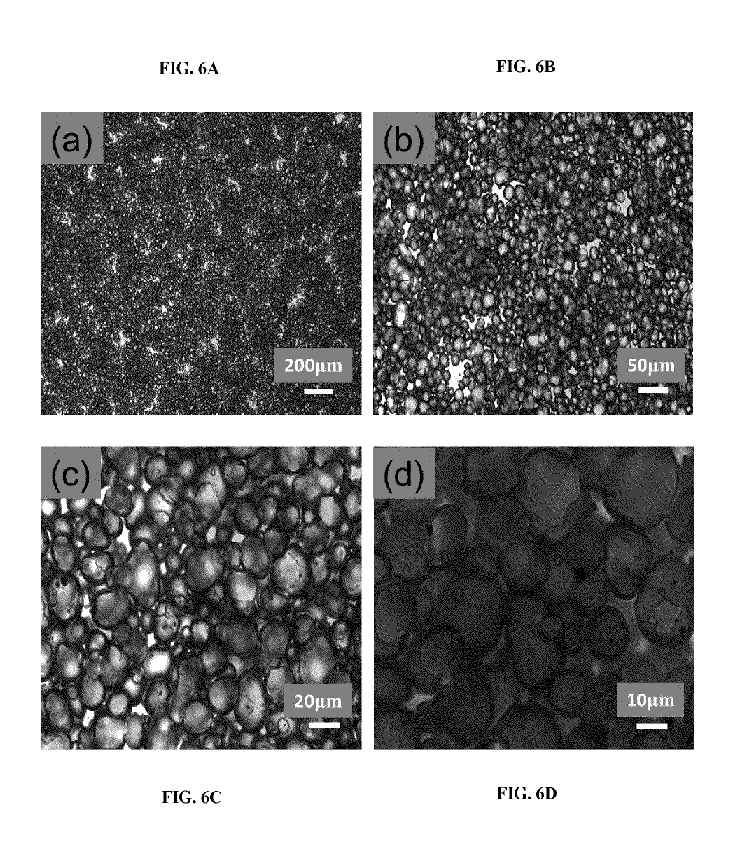

For electronics, the porous material can be used to improve the electrical conductivity with a very low loading of conductive nanoparticles. For example, in some aspects, the carbon nanoparticles are concentrated at the surface of the pores with good dispersion (no agglomeration can be observed). This special distribution of nanoparticles reduces the nanoparticle loading required for electron conduction. At the same time, the dimensional stability is improved as compared with traditional conductive nanocomposites since there is more free volume (i.e. pores), inside the material, which can absorb the volume change induced by environment variations, such as temperature. At the same time, the porous structure will also remarkably improve the specific conductivity (conductivity per mass) as compared with conventional non-porous conductive nanocomposites, which are be desired for the electronic materials employed for aerospace applications. FIG. 5 and FIG. 6 are SEM images for the samples with CNFs as the conductive filler, which shows similar structures as introduced for the above samples with CNTs.

For energy storage devices, the porous materials can be functionalized as a 3D electrode and can be tailored to the application. For example, by using electrochemically active nanoparticles (NPs), such as carbon NPs (carbon nanotubes (CNTs), CNF or graphene) which are frequently used as the anode material for lithium-ion batteries, porous materials with NPs concentrated at the pore surface can be obtained. Due to its large surface/interface area, the resulting structure constitutes a powerful 3D anode that can be used in a battery or capacitor. At the same time, in some aspects, this porous material is flexible or stretchable depending on the polymer matrix used. It is noted that existing nanotechnologies for fabricating 3D electrodes are either very costly or complicated with difficulties in control over the procedures, which results in less environmentally benign production for scalable application. For example, three-dimensional bicontinuous nanoporous electrodes can be prepared based on electrode position and chemical etching techniques.

Porous Polymer Nanocomposite Materials for Sensor Applications

In another aspect, the porous polymer nanocomposite materials have pores functionalized with nanoparticles with special properties for sensors, such as CuO and/or MoS₂ particles. For sensors, in some embodiments, the porous structure with well-dispersed nanoparticles/active materials on the pore surface will provide a high specific surface area, which enhances the sensitivity of a sensor. In some embodiments, the porous structure also provides the property of permeability, which is also important for sensors.

Porous Polymer Nanocomposite Materials for Catalytic Applications

In another aspect, the porous polymer nanocomposite materials have pores functionalized by catalytic particles, such as RuO₂, and/or MnO₂ nanoparticles, and an active composite film with catalytic properties.

While examples of certain porous polymer nanocomposite materials are described based on their applications, it is understood that the uses of such porous polymer nanocomposite materials are not limited to those specifically described herein. Other applications are also contemplated. The technology combines the advantages of polymer materials (good mechanical properties) and the advantages of porous structures (high surface area). Via functionalizing the pores by various nanomaterials, the porous materials can be functionalized to satisfy a specific application.

Properties of Porous Polymer Materials

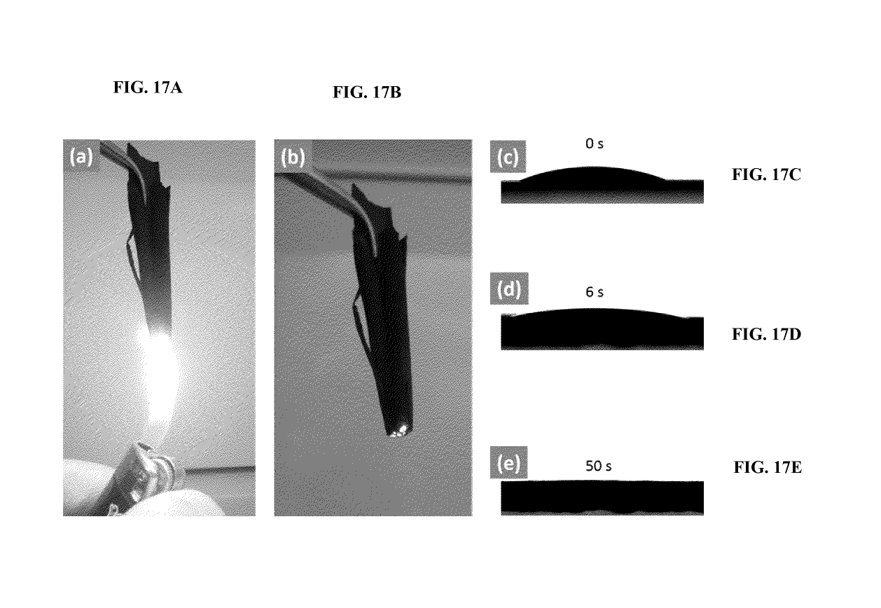

An aspect of the present disclosure is to provide porous polymer materials of the present disclosure that demonstrate flame-retardant properties. FIGS. 17(a) and 17(b) demonstrate the flame-retardant behavior of an embodiment where the D²-PNC film with ca. 28 wt % CNTs.

Another aspect of the present disclosure is to provide porous polymer materials of the present disclosure that demonstrate an ability to absorb liquid electrolyte to establish ion-conductive pathway and interface for energy storage. IN some embodiments, the practical applications, such as electrodes for batteries or supercapacitors, utilize a D2-PNC film that is able to absorb liquid electrolyte to establish ion-conductive pathway and interface for energy storage. FIGS. 17(c)-17(e) present snapshots of the contact angle during different time (eg. liquid electrolyte, lithium perchlorate in propylene carbonate, 1 mol/L) for a droplet on the back surface of D²-PNC (porous side). The wetting behavior of a liquid electrolyte (lithium perchlorate in propylene carbonate, 1 mol/L) on the porous surface of the D²-PNC film with ca. 28 wt % CNTs was investigated, and the D²-PNC film can absorb the liquid electrolyte well as the liquid droplet disappeared in ca. 50 seconds.

Emulsion Compositions

In accordance with another aspect, an emulsion composition is provided. The emulsion composition comprises a first phase and a second phase forming the emulsion. The first phase and the second phase are not miscible. The first phase comprises a suspension of nanoparticles in a first solvent in which the nanoparticles can form a suspension. The first phase may or may not comprise other additives such as a polymer soluble in the first solvent. The second phase comprises a polymer solution in a second solvent which can dissolve the polymer at a desired concentration. The second phase may or may not comprise other additives such as a type of nanoparticles.

The first solvent and the second solvent are not miscible in each other. In some aspects, the solubility of the first solvent in the second solvent, and vice versa, is no more than about 5 g/100 mL, or no more than about 2 g/100 mL, or no more than about 1 g/100 ml, at 20° C. In some aspects, the first solvent and second solvent have a boiling point of between about 35° C. to about 150° C., such as between about 40° C. to about 120° C., between about 50° C. to about 110° C., or between about 60° C. to about 100° C., and are liquid at room temperature (between about 20° C. to about 30° C.). The emulsion composition is used in preparing a porous polymer nanocomposite material described herein.

For example, water and oil phases are two immiscible liquid phases (solutions or suspensions). In some aspects, the first solvent is water and the second solvent is a water-immiscible organic solvent. In some aspects, the first solvent is a water-immiscible organic solvent and the second solvent is water. Examples of water-immiscible organic solvents include, but are not limited to, dichloromethane, chloroform, carbon tetrachloride, 1,2-dichloroethane, methyl-tert-butyl ether, C5-C12 alkanes (alkanes having 5 to 12 carbon atoms, e.g., hexane and dodecane), C5-C8 cycloalkanes (cycloalkanes having 5 to 8 carbon atoms, e.g., cyclohexane), benzene, toluene and/or xylenes.

In some aspects, the nanoparticles comprise conductive nanoparticles, such as carbon nanotubes (CNTs), carbon nanofibers (CNFs), and/or metal nanoparticles. In some aspects, the nanoparticles comprise magnetic particles, such as Fe₃O₄. In some aspects, the nanoparticles comprise catalytic particles, such as RuO₂, and/or MnO₂ particles. In some aspects, the nanoparticles comprise electrode particles, such as silicon, sulfur, carbon nanotubes, and/or graphene. In some aspects, the nanoparticles comprise sensor particles CuO and/or MoS₂ particles.

In some aspects, the nanoparticles are carbon nanotubes, such as multi-wall carbon nanotubes and/or single-wall carbon nanotubes.

In some aspects, the first phase further comprises a conductive polymer, such as those described herein. Examples of conductive polymers include non-heteroatom containing polymers, such as poly(fluorene)s, polyphenylenes, polypyrenes, polyazulenes, polynaphthalenes, poly(acetylene)s (PAC) and poly(p-phenylene vinylene) (PPV); nitrogen-containing polymers, such as poly(pyrrole)s (PPY), polycarbazoles, polyindoles, polyazepines, and polyanilines (PANI); and sulfur-containing polymers, such as poly(thiophene)s (PT), poly(3,4-ethylenedioxythiophene) (PEDOT), and poly(p-phenylene sulfide) (PPS).

In some aspects, the conductive polymer comprises poly(3,4-ethylenedioxythiophene) and/or polystyrene sulfonate.

In some aspects, the concentration of the nanoparticles in the first phase is from about 0.001 wt % to about 90 wt % of the first phase. In some aspects the concentration of the nanoparticles in the first phase is about 0.001 wt %, about 0.005 wt %, about 0.01 wt %, about 0.05 wt %, about 0.1 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt % of the first phase, or is within any range between any two of the values (end points inclusive).

Examples of polymers in the second phase include polycarbonate, polyethylenimine, polyetherimide, and/or polybutadiene. Additives, such as nanoparticles, can also be introduced into the polymer solution to form the second phase.

In some aspects, the concentration of the polymer in the second phase is from about 0.001 wt % to about 99 wt % of the oil phase. In some aspects the concentration of the polymer in the second phase is about 0.001 wt %, about 0.005 wt %, about 0.01 wt %, about 0.05 wt %, about 0.1 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt %, about 95 wt %, about 99 wt %, of the second phase, or is within any range between any two of the values (end points inclusive). In some aspects, the concentration of the polymer in the second phase is from about 1 wt % to about 10 wt %.

In some aspects, the ratio of the nanoparticles in the first phase and the polymer in the second phase is from about 0.01 wt % to about 99 wt %. In some aspects the ratio is about 0.01 wt %, about 0.05 wt %, about 0.1 wt %, about 0.2 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 45 wt %, about 50 wt %, about 60 wt %, about 70 wt %, about 80 wt %, about 90 wt %, about 99 wt %, or is within any range between any two of the values (end points inclusive). In some aspects, the weight ratio of the nanoparticles in the first phase and the polymer in the second phase is from about 1:1 to about 10:1, such as about 2:1, about 3:1, about 4:1, about 5:1, about 6:1, about 7:1, about 8:1, or about 9:1. In some aspects, the weight ratio of the nanoparticles in the first phase and the polymer in the second phase is within any range between any two of the above values (end points inclusive).

In some aspects, the volume ratio of the first phase to the second phase is from about 0.001:1 to about 1000:1. In some aspects, the volume ratio of the first phase to the second phase is about 0.001:1, about 0.005:1, about 0.01:1, about 0.05:1, about 0.1:1, about 0.5:1, about 1:1, about 2:1, about 5:1, about 10:1, about 50:1, about 100:1, about 500:1, or about 1000:1, or is within any range between any two of the values (end points inclusive). In some aspects, the volume ratio of the first phase to the second phase is from about 0.01:1 to about 0.5:1, or from about 0.05:1 to about 0.3:1.

In some aspects, provided is a water/oil emulsion composition comprising a water phase and an oil phase, wherein the water phase comprises nanoparticles suspended in water, and the oil phase comprises a solution comprising a polymer and a water-immiscible organic solvent, such as a water-immiscible organic solvent described herein or a mixture thereof.

In some aspects of the water/oil emulsion composition, the nanoparticles comprise conductive nanoparticles, such as carbon nanotubes, carbon nanofibers, and/or metal nanoparticles. In some aspects, the nanoparticles comprise magnetic particles, such as Fe₃O₄. In some aspects, the nanoparticles comprise catalytic particles, such as RuO₂, and/or MnO₂ particles. In some aspects, the nanoparticles comprise electrode particles, such as silicon, sulfur, carbon nanotubes, and/or graphene. In some aspects, the nanoparticles comprise sensor particles CuO and/or MoS₂ particles.

In some aspects of the water/oil emulsion composition, the nanoparticles are carbon nanotubes, such as multi-wall carbon nanotubes and/or single-wall carbon nanotubes.

In some aspects of the water/oil emulsion composition, the water phase further comprises a conductive polymer, such as those described herein. In some aspects of the water/oil emulsion composition, the conductive polymer comprises poly(3,4-ethylenedioxythiophene) and/or polystyrene sulfonate.

In some aspects of the water/oil emulsion composition, the concentration of the nanoparticles in the water phase is from about 0.001 wt % to about 90 wt % of the water phase. In some aspects the concentration of the nanoparticles in the water phase is about 0.001 wt %, about 0.005 wt %, about 0.01 wt %, about 0.05 wt %, about 0.1 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt % of the water phase, or is within any range between any two of the values (end points inclusive).

Examples of oil phase include, but are not limited to, polycarbonate in chloroform, polyetherimide in chloroform or other polymers in chloroform, polybutadiene in dodecane or other polymers in nonpolar solvent such as C5-C12 alkanes, C5-C8 cycloalkanes, and/or benzene. Additives, such as nanoparticles can also be introduced into the polymer solution to form the oil phase.

In some aspects of the water/oil emulsion composition, the polymer in the oil phase comprises polycarbonate, polyetherimide, polybutadiene or polyethylenimine, or a mixture thereof. In some aspects of the water/oil emulsion composition, the polymer in the oil phase comprises polycarbonate.

In some aspects of the water/oil emulsion composition, the organic solvent comprises dichloromethane, chloroform, carbon tetrachloride, 1,2-dichloroethane, methyl-tert-butyl ether, a C5-C12 alkane, a C5-C8 cycloalkane, benzene, toluene or a xylene, or a mixture thereof. In some aspects, the organic solvent comprises chloroform.

In some aspects of the water/oil emulsion composition, the concentration of the polymer in the oil phase is from about 0.001 wt % to about 90 wt % of the oil phase. In some aspects the concentration of the polymer in the oil phase is about 0.001 wt %, about 0.005 wt %, about 0.01 wt %, about 0.05 wt %, about 0.1 wt %, about 0.5 wt %, about 1 wt %, about 2 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, about 90 wt % of the oil phase, or is within any range between any two of the values (end points inclusive). In some aspects, the concentration of the polymer in the oil phase is from about 1 wt % to about 10 wt %.

In some aspects of the water/oil emulsion composition, the ratio of the nanoparticles in the water phase and the polymer in the oil phase is from about 0.01 wt % to about 90 wt %. In some aspects, the ratio is about 0.01 wt %, about 0.05 wt %, about 0.1 wt %, about 0.2 wt %, about 0.5 wt %, about 1 wt %, about 2 wt %, about 5 wt %, about 10 wt %, about 5 wt %, about 10 wt %, about 15 wt %, about 20 wt %, about 25 wt %, about 30 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt. In some aspects of the water/oil emulsion composition, the weight ratio of the nanoparticles in the water phase and the polymer in the oil phase is from about 1:1 to about 10:1, such as about 2:1, about 3:1, about 4:1, about 5:1, about 6:1, about 7:1, about 8:1, or about 9:1. In some aspects of the water/oil emulsion composition, the weight ratio of the nanoparticles in the water phase and the polymer in the oil phase is within any range between any two of the above values (end points inclusive).

In some aspects of the water/oil emulsion composition, the volume ratio of the water phase to the oil phase is from about 0.001:1 to about 1000:1. In some aspects, the volume ratio of the water phase to the oil phase is about 0.001:1, about 0.005:1, about 0.01:1, about 0.05:1, about 0.1:1, about 0.5:1, about 1:1, about 5:1, about 10:1, about 50:1, about 100:1, about 500:1, or about 1000:1, or is within any range between any two of the values (end points inclusive). In some aspects of the water/oil emulsion composition, the volume ratio of the water phase to the oil phase is from about 0.01:1 to about 0.5:1, or from about 0.05:1 to about 0.3:1.

In some aspects, the emulsion compositions described above, such as the water/oil emulsion compositions, further comprise a surfactant. In some aspects, the emulsion compositions described above, such as the water/oil emulsion compositions, do not comprise any surfactant. In some aspects, the emulsion composition, or the first (e.g., water) phase and/or the second (e.g., oil) phase, comprises 0 wt % to about 10 wt % of a surfactant, such as 0 wt %, about 0.001 wt %, about 0.005 wt %, about 0.01 wt %, about 0.05 wt %, about 0.1 wt %, about 0.2 wt %, about 0.5 wt %, about 1 wt %, about 2 wt %, about 5 wt %, about 10 wt %, or within any range between any two of the values (end points inclusive).

The surfactants may be anionic, non-ionic, cationic and/or amphoteric surfactants. Examples of anionic surfactants include, but are not limited to, soaps, alkylbenzenesulfonates, alkanesulfonates, olefin sulfonates, alkyl ether sulfonates, glycerol ether sulfonates, alpha-methyl ester sulfonates, sulfo fatty acids, alkyl sulphates, fatty alcohol ether sulphates, glycerol ether sulphates, fatty acid ether sulphates, hydroxy mixed ether sulphates, monoglyceride (ether) sulphates, fatty acid amide (ether) sulphates, mono- or dialkyl sulfosuccinates, mono- or dialkyl sulfosuccinamates, sulfotriglycerides, amide soaps, ether carboxylic acids or salts thereof, fatty acid isethionates, fatty acid sarcosinates, fatty acid taurides, N-acylamino acids, e.g. acyl lactylates, acyl tartrates, acyl glutamates and acyl aspartates, alkyl oligoglucoside sulphates, protein fatty acid condensates (e.g., wheat-based vegetable products) and alkyl(ether)phosphates. Examples of non-ionic surfactants include, but are not limited to, fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers or mixed formals, optionally partially oxidized alkyl oligoglycosides, optionally partially oxidized alkenyl oligoglycosides or glucoronic acid derivatives, fatty acid N-alkylglucamides, protein hydrolysates (e.g, wheat-based vegetable products), polyol fatty acid esters, sugar esters, sorbitan esters, polysorbates and amine oxides. Examples of amphoteric or zwitterionic surfactants include, but are not limited to, alkylbetaines, alkylamidobetaines, aminopropionates, aminoglycinates, imidazolinium-betaines and sulfobetaines. Surfactants also include fatty alcohol polyglycol ether sulphates, monoglyceride sulphates, mono- and/or dialkyl sulfosuccinates, fatty acid isethionates, fatty acid sarcosinates, fatty acid taurides, fatty acid glutamates, alpha-olefinsulfonates, ether carboxylic acids, alkyl oligoglucosides, fatty acid glucamides, alkylamidobetaines, amphoacetals and/or protein fatty acid condensates. Examples of zwitterionic surfactants include betaines, such as N-alkyl-N,N-dimethylammonium glycinates, N-acylaminopropyl-N,N-dimethylammonium glycinates having in each case 8 to 18 carbon atoms in the alkyl or acyl group, for example cocoalkyldimethylammonium glycinate, cocoacylaminopropyldimethylammonium glycinate, and cocoacylaminoethylhydroxyethyl-carboxymethyl glycinate, and 2-alkyl-3-carboxymethyl-3-hydroxyethylimidazolines.

The emulsion compositions described above, such as the water/oil emulsion compositions, or the first phase (such as the water phase) and/or the second phase (such as the oil phase), may further comprise other additives that may be present in porous polymer nanocomposite materials.

In some aspects, the emulsion compositions described above, such as the water/oil emulsion compositions, or the first phase (such as the water phase) and/or the second phase (such as the oil phase), do not comprise polymerizable monomer compounds, such as styrene-divinylbenzene, methacrylate, methyl methacrylate (MMA), and ethylene glycol dimethylacrylate (EGDMA). In some aspects, the emulsion compositions described above, such as the water/oil emulsion compositions, or the first phase (such as the water phase) and/or the second phase (such as the oil phase), do not comprise a compound that can initiate a polymerization reaction, such as sodium nitrite.

In some aspects, the emulsion compositions described above, such as the water/oil emulsion compositions, do not comprise a structure-directing agent, a transient anchoring agent, precursors of nanoparticles which can form nanoparticles in situ, or polymeric particles, such as ultra-high molecular weight polyethylene polymeric particles.

Methods

In accordance with another aspect, a method of preparing a porous polymer nanocomposite material is provided. The method comprises preparing an emulsion composition described herein comprising a first phase and a second phase by mixing the first phase with the second phase. In some aspects, the mixing comprises ultrasonication, or mechanical mixing, and so on. The first phase comprises a suspension of nanoparticles in a first solvent. The second phase comprises a polymer solution in a second solvent. The first solvent and the second solvent are not miscible. The emulsion composition is then cast on a substrate to form a film. The film is dried to form the porous polymer nanocomposite material.

In some aspects, the method comprises preparing a water/oil emulsion composition described herein comprising a water phase and an oil phase by mixing the water phase with the oil phase. In some aspects, the mixing comprises ultrasonication. The water phase comprises a suspension of nanoparticles in water. The oil phase comprises a polymer solution in a water immiscible organic solvent. The water/oil emulsion composition is then cast on a substrate to form a film. The film is dried to form the porous polymer nanocomposite material.

In some aspects, the method further comprises preparing the first (e.g., water phase) by a method comprising ultrasonication of a mixture comprising the nanoparticles and the first solvent (e.g., water). In some aspects, the method further comprises preparing the second (e.g., oil phase) by a method comprising dissolving the polymer in the second solvent (e.g., the water immiscible organic solvent).

Various substrates can be used for the fabrication of the porous composite film, including nonconductive substrates (e.g., glass), conductive substrate (e.g., metals, conductive polymer composites, etc.), and magnetic substrates and so on. In some aspects, the substrate is a glass substrate. Methods of casting the emulsion compositions are known in the art.

The thickness of the film may vary. In some aspects, the thickness of the film is from about 1 μm to about 10 mm, or to about 5 mm, or to about 1 mm, or to about 500 μm, or to about 100 μm, or to about 50 μm, or to about 10 μm. Examples of the thickness include about 10 mm, about 5 mm, about 1 mm, about 500 μm, about 100 μm, about 50 μm, about 10 μm, or about 1 μm, or any ranges between two of the values (end points inclusive).

The film can be dried either at room temperature or a controlled environment (such as elevated temperatures and/or reduced pressure). In some aspects, the drying comprises evaporating solvents (e.g., the water and the organic solvent) at a temperature of from about 30° C. to about 100° C., for example, about 75° C.

In some aspects, the methods do not comprise a polymerization step wherein monomers polymerize in the emulsion composition, or in the first phase or the second phase. In some aspects, the methods do not comprise any chemical reaction wherein a covalent bond is formed between two components in the emulsion composition, or in the first phase or the second phase.

The methods described herein provide a facile, cost-effective and universal approach for fabrication of advanced nanocomposites with controlled distribution and dispersion of nanoparticles by emulsion technology, which can effectively boost the functionalizations of polymeric nanocomposites. In some aspects, the nanoparticles in the porous polymeric nanocomposites are distributed on the surface of the pores with highly uniform dispersion. Further, the distribution of nanoparticles associated with the porous structures can be adjusted by varying the ratio of the two phases as well as the concentration of nanoparticles in the suspension (first phase). In some aspects, the controlled dispersion and distribution of conductive nanoparticles (e.g., MWCNTs) provides the composites (e.g., a polycarbonate nanocomposite) a low percolation value (e.g., <0.06 vol. %) for electronic conduction.

Various porous polymer nanocomposite materials can be prepared by the procedure if the polymer used in the material can be dissolved in a solvent (water or other organic solvents) and the functional components (nanoparticles or active materials for the functionalizations) can be dispersed/dissolved in another solvent which is not miscible with the solvent for the polymer. It is noted that the functionalizations can be introduced by the design of the compositions in either phase based on the properties of the components and the specific interactions among the components.

### Example

This example relates to a facile, cost-effective, robust and universal method for fabrication of porous nanocomposites with well-controlled distribution and dispersion of nanoparticles (NPs) (e.g., carbon nanotubes, CNTs, such as multi-wall carbon nanotubes (MWCNTs)) based on emulsion technology. Via design of the compositions in the water phase (e.g., a homogeneous aqueous suspension of CNTs) as well as in the oil phase (polymer solution with organic solvent), a water/oil (W/O) emulsion system was prepared by ultrasonication for the fabrication of the nanocomposites. The CNTs in the water phase suspension acted as a surfactant and resulted in a stable emulsion. After the emulsion was casted and dried on a substrate (glass, for example), a porous nanocomposite film with controlled distribution and dispersion of CNTs was obtained. It is believed that this is a scalable technology and can be easily commercialized, thus, is useful for mass production of porous multi-functional nanocomposites.

Materials

The materials employed in this example include: polycarbonate (PC) (SABIC Innovation Plastics), MWCNT (diameter: 10-20 nm, length: 10-30 μm, Cheap Tubes Inc.), poly(3,4-ethylenedioxythiophene)polystyrene sulfonate (PEDOT:PSS) aqueous solution (concentration: 1.13 wt %, high conductive grade, Sigma-Aldrich), and solvents (chloroform and DI water).

Sample Preparation

The water phase was prepared by dispersing CNTs in aqueous solution of PEDOT:PSS by ultrasonication (20% amplitude for 5 minutes with ice bath, Branson Digital Untrasonicator, Model 450). For masterbatch, the ratio between CNTs and PEDOT:PSS solution was fixed around 0.5 g:10 mL. For the samples with different loading of NPs or different W/O ratio, the masterbatch of the nano-dispersion was diluted by DI water appropriately according to the calculation. The oil phase, that is, the polymer solution (PC in chloroform, 5 wt %) was prepared. The well-dispersed CNT/PEDOT:PSS suspension (water phase) was added into the polymer solution (oil phase) and a W/O emulsion was obtained by ultrasonication of the mixture (Branson Digital Ultrasonicator, 20% amplitude, 3 minutes with ice bath). The emulsion was cast on a glass substrate via a multiple clearance square applicator (Paul N. Gardner Company, Inc.). The thickness of the film was controlled by casting the emulsion with different gap values. After solvents (chloroform and water) evaporation at room temperature for about 10 minutes, a porous nanocomposite film with some residual water was obtained and further dried at 75° C. for 1 hour to completely remove the solvents before the electrical measurement.

Characterizations

The microstructures were characterized by scanning electron microscopy (FEI Quanta 200F) and optical microscope. The surface contacted with the glass substrate was directly used for SEM observation. The fracture surface of the porous film was prepared by fracturing the film in liquid nitrogen. For optical image, the thinnest film with thickness of ca. 15 μm was used and the images were taken at room temperature by Olympus BX51. For electrical conductivity measurement, the resistance of the film was measured for 5 times for each sample by two-probe method at ambient temperatures using 2410 SourceMeter (KEITHLEY, Inc.) The conductivity was calculated by ρ=RA/l, where R is the resistance obtained from the measurement, A is the area of the section, l is the length of the sample used for the testing.

Results

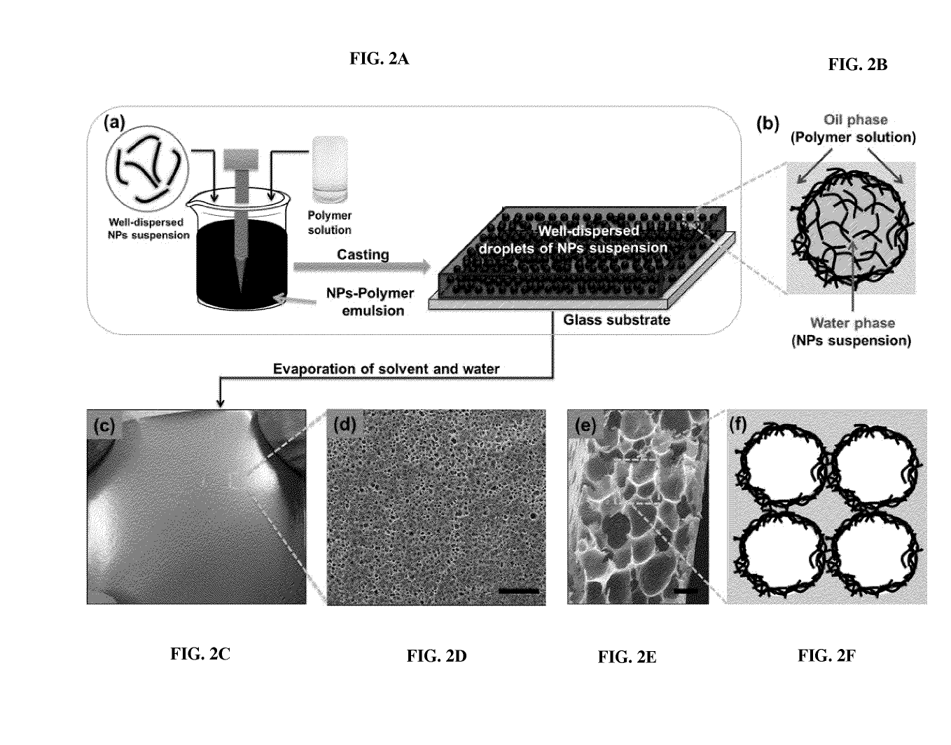

Emulsion technology has been widely used for fabrication of porous materials However, disclosed herein is the first design of the compositions in the water phase as well as the oil phase for the fabrication of porous nanocomposites. As illustrated in the FIG. 2(a), a well-dispersed NP suspension (CNT treated by PEDOT:PSS and dispersed in DI water) as the water phase and a polymer solution (polycarbonate in chloroform) as the oil phase have been employed to form a W/O emulsion system. During ultrasonication, the NP suspension is broken into micro droplets. The compositions as well as the structures of the W/O system are further illustrated in FIG. 2(b). It is noted that the W/O emulsion system can be stable without surfactant due to the NP in the water phase. By casting the emulsion on a glass substrate, the solvents (chloroform for the oil phase and water for the water phase) are removed during evaporation and a porous nanocomposite can be obtained as shown FIG. 2(c). The porous structures are confirmed by the SEM images (FIGS. 2(d) and 2(e)). FIG. 2(f) demonstrates the controlled distribution of MWCNT in the porous nanocomposites. In brief, the design of the compositions in the water phase (nanoparticle suspension, for example) for the emulsion system provides a versatile, simple and effective approach to fabrication of nanocomposites, especially porous polymeric nanocomposites, with controlled distribution and dispersion of NPs. It is contemplated that any two immiscible liquid phases can be used for constructing an emulsion system and the distribution of the components can be controlled after the removing of the solvent. The flexibility in the design of the compositions in the two phases will enable programmable functionalities for nanocomposites.

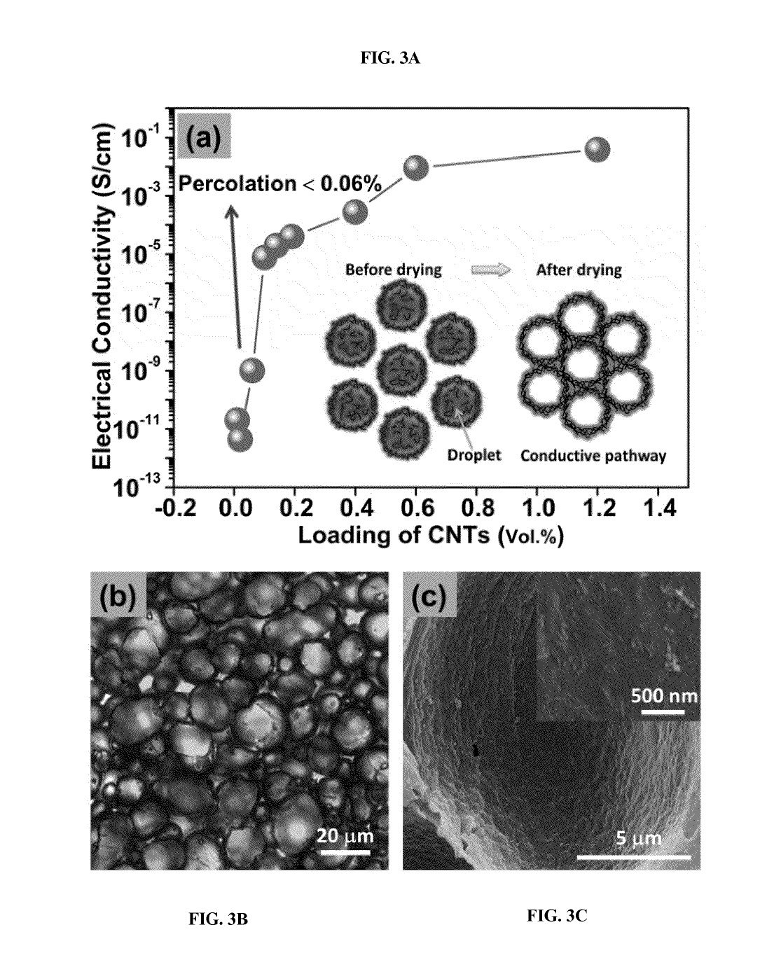

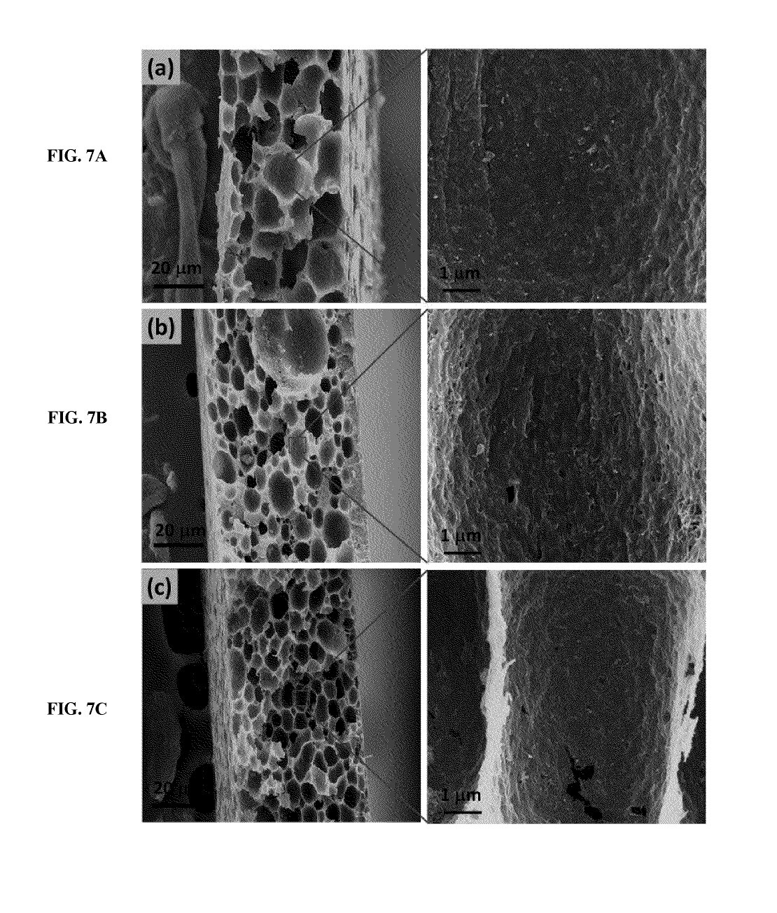

To investigate how the structure affects the properties of the porous nanocomposites, the loading of the CNTs was changed from 0 to 6 wt % and the electrical conductivity was measured. As shown in FIG. 3(a), the electrical conductivity increases non-linearly with the loading of CNTs, similar to that for bulk conductive nanocomposites. However, it is noted that a very low percolation loading (<0.06 vol. % or 0.3 wt %) was obtained as indicated in FIG. 3(a). This percolation loading is much lower than that of common PC/CNT nanocomposites, which is usually well above 1 wt %. The low threshold for percolation is due to the controlled distribution and a good dispersion of CNTs in the porous composite film as illustrated by the cartoon in FIG. 3(a). Because the nanotubes are trapped in the micro droplets, the final distribution of nanotubes is shaped by the dried droplets, that is, the pore structures. As long as the concentration of the droplets is high enough to construct a network, a network of conductive nanotubes will also form at the percolation point. This coupling effect is further confirmed by the optical images (FIG. 3(b) and FIG. 6) and SEM images (FIG. 3(c) and FIG. 7). From the optical images, a clear network of the pores was observed. The SEM images distinctly show a distribution and a good dispersion of CNTs on the surface of the pores. The above findings indicate that the distribution and the dispersion of NPs can be effectively controlled by individual design of the compositions in the water or oil phase for the emulsion system.

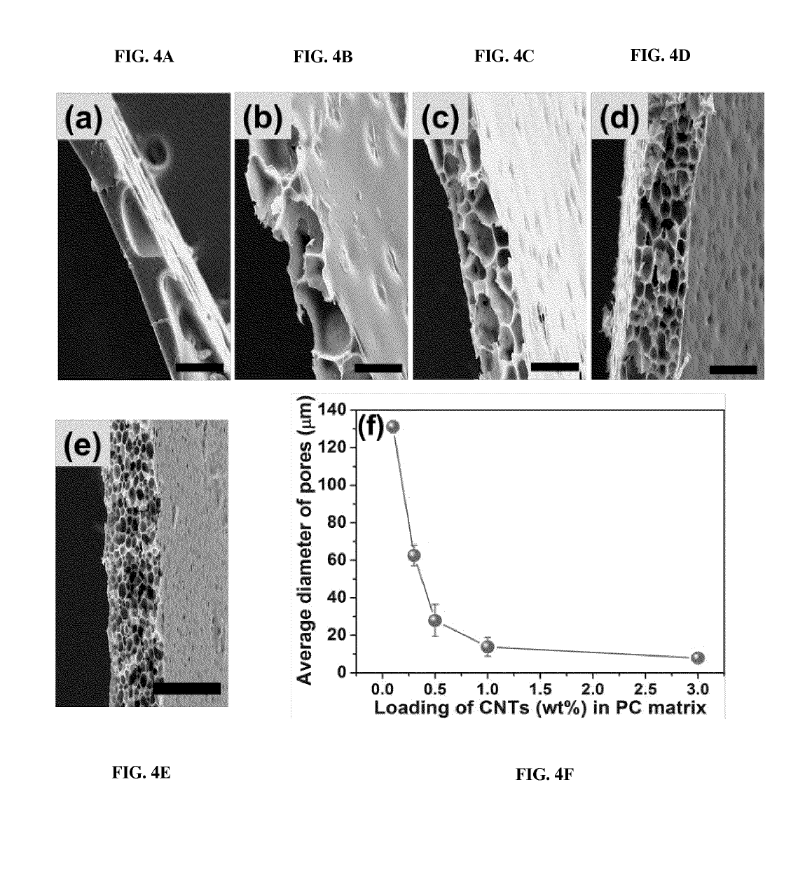

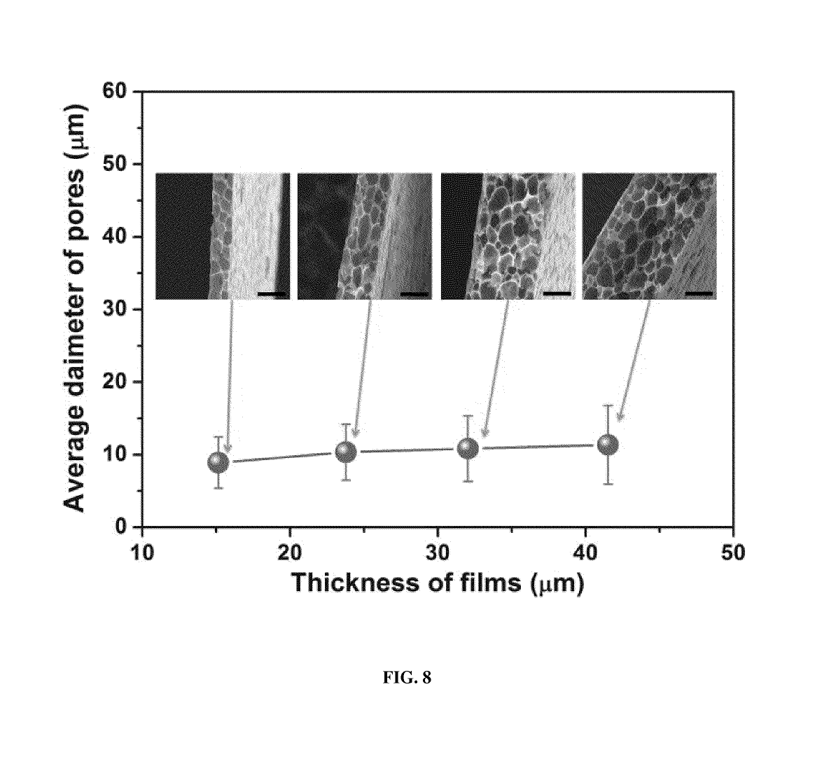

A significant finding as shown in FIG. 4 is that the pore structures, that is, the distribution of CNTs, can be simply but effectively manipulated through the loading of the NPs, that is, the concentration of the NPs in the water-based suspension if a constant W/O is used. It was found that the diameter of the pores decreases with the increase of the nanotube loading when the loading is less than 1 wt % as shown by the SEM images and the statistical results of the pore size in FIG. 4. It was also found that the pore size shows much less dependent behavior on the loading of CNTs when the CNT loading is higher than 1 wt %, indicating that the water droplet becomes stable when the concentration of CNTs in the droplet is higher than 0.3 wt % (the CNT concentration in the droplet for the sample with 1 wt % CNT in the final composite). Based on FIG. 4, a higher concentration of NPs in the suspension (ca. 0.3 wt %) is useful to stabilize the micro droplets and suppress the coalescence of micro droplets, which results in a smaller pore size. At the same time, it was found that the pore size increased slightly with the increasing of the thickness of the film (FIG. 8), likely due to the extra time provided for the thicker film to evaporate. These results once again confirm that CNTs can act as a surfactant for the emulsion. The above finding indicates that the individual design of the compositions in water or oil phase will provide a very effective approach to fabricating porous nanocomposites with high concentration of functional NPs, which will find significant applications into technologies such as electrodes, sensors and catalytic films.

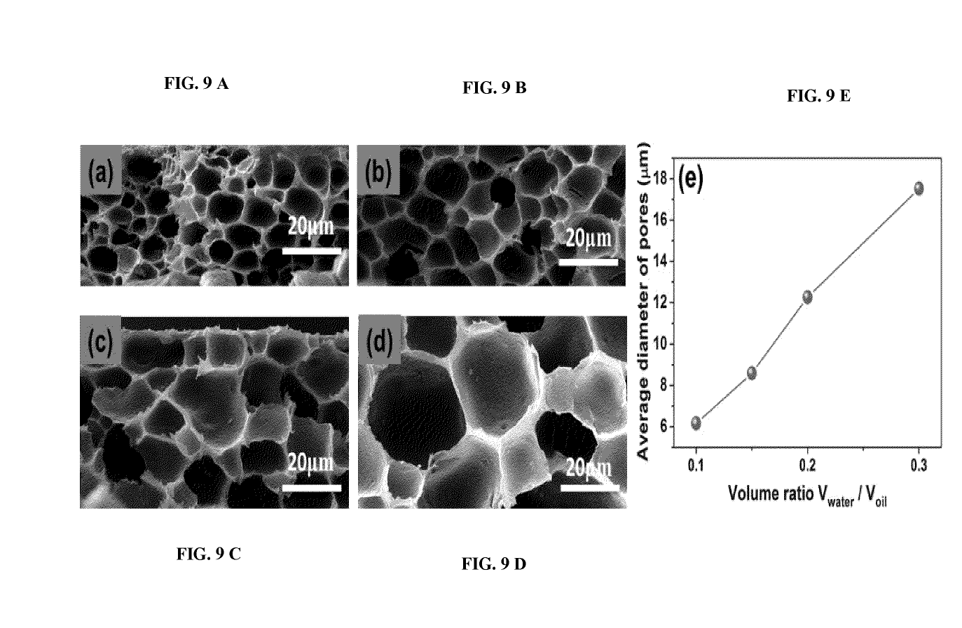

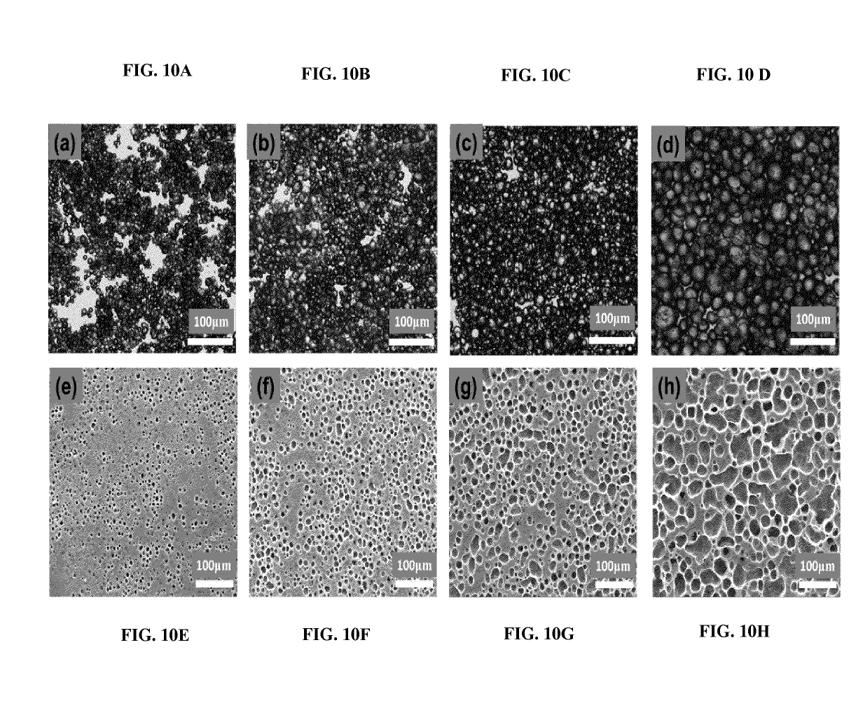

The distribution of NPs in the porous nanocomposite can also be controlled by altering the W/O ratio. In this example, a volume ratio of the water phase (W) to the oil phase (0) ranged from 0.05 to 0.3 was investigated. To evaluate the effects of W/O volume ratio on the structures and properties of the porous composite films, a constant overall loading of CNTs (2 wt %) was applied for all these samples. It was seen that the range of the volume ratio is primarily determined by the stability of the W/O system. As shown in FIG. 5, the W/O ratio influences the structures and the properties of the porous nanocomposites. For example, the pore size increases notably with the W/O ratio as shown in the optical images (FIG. 5(a)-5(d)) and SEM images (FIG. 9). The explanation of this result is the same as that for the NP loading dependent behavior of the pore size, that is, a high concentration of NPs in the nano-dispersion helps to stabilize the micro droplets. As the increase in the W/O ratio can dilute the concentration of the nanotubes in the suspension for a constant overall loading of nanotubes, more coalescence of the micro droplets occurs and bigger pores can be obtained. Besides the pore size, the distribution of the pores is also affected by the W/O ratio. Based on the optical images in FIGS. 5 and 10, it was found that increasing W/O ratio also improves the uniformity of the pore distribution, that is, the NP distribution. FIG. 5(e) highlights the changes in the distribution of the nanotubes with the increasing of the W/O ratio. For a lower W/O ratio, a “fine but inhomogeneous” distribution of nanotubes coupled with smaller pores can be obtained, while, a high W/O ratio will give rise to a “coarse but homogeneous” distribution of the nanotubes. The significance of this change in the nanobute distribution has been shown by the W/O ratio dependent behavior of the electrical conductivity in FIG. 5(f). The fact that the electrical conductivity increases with the W/O ratio implying that a higher W/O ratio can effectively facilitate the formation of a continuous conductive pathway with the same amount of conductive nanofillers.

In addition to electrical conductivity, it has been reported that the increase in the porosity will remarkably reduce the thermal conductivity. For the porous film with different W/O ratios, the higher the W/O ratio, the higher the porosity as indicated by the optical images since the porous structures are formed by the water phase. Therefore, a higher W/O ratio is favorable for the improvement of the thermoelectric figure of merit ZT, which is proportional to the product σ/k (σ, the electrical conductivity, k, the thermal conductivity) and the key parameter describing the properties of a thermoelectrical material. Without wishing to be bound by theory, it is believed that the controllable porous structure coupled with the special distribution of NPs could provide an effective solution for achieving high electrical conductivity but low thermal conductivity, that is, a higher thermoelectric figure of merit ZT, which is very significant for thermoelectrical materials.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible sub ranges and combinations of sub ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into sub ranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A porous polymer nanocomposite material comprising nanoparticles and a polymer matrix comprising pores, wherein at least about 10% of the nanoparticles are on the surface of the pores.

2. The porous polymer nanocomposite material of claim 1, wherein at least 50% of the nanoparticles are on the surface of the pores.

3. The porous polymer nanocomposite material of claim 1, wherein the nanoparticles are selected from the group consisting of conductive nanoparticles, magnetic nanoparticles, catalytic nanoparticles, electrode nanoparticles, sensor nanoparticles, and combinations thereof.

4. The porous polymer nanocomposite material of claim 1, wherein the polymer is selected from the group consisting of polycarbonate, polyetherimide, polybutadiene, and combinations thereof.

5-8. (canceled)

9. A water/oil emulsion composition comprising a water phase and an oil phase, wherein
the water phase comprises nanoparticles suspended in water; and
the oil phase comprises a solution comprising a polymer and a water-immiscible organic solvent.

10. The water/oil emulsion composition of claim 9, wherein the nanoparticles comprise conductive nanoparticles, magnetic nanoparticles, catalytic nanoparticles, electrode nanoparticles, sensor nanoparticles, or a combination thereof.

11. The water/oil emulsion composition of claim 9, wherein the nanoparticles comprise carbon nanotubes.

12. The water/oil emulsion composition of claim 9, wherein the nanoparticles are multi-wall carbon nanotubes.

13. The water/oil emulsion composition of claim 9, wherein the water phase further comprises a conductive polymer.

14. The water/oil emulsion composition of claim 13, wherein the conductive polymer comprises poly(3,4-ethylenedioxythiophene), polystyrene sulfonate, polyaniline, poly(thiophene)s, poly(pyrrole)s, polycarbazoles, polyindoles, polyazepines, poly(acetylene)s, poly(p-phenylene vinylene), poly(fluorene)s, polyphenylenes, polypyrenes, polyazulenes, and/or polynaphthalenes.

15. The water/oil emulsion composition of claim 13, wherein the conductive polymer comprises poly(3,4-ethylenedioxythiophene) and/or polystyrene sulfonate.

16. The water/oil emulsion composition of claim 9, wherein the concentration of the nanoparticles in the water phase is from about 0.001 wt % to about 90 wt % of water phase.

17. The water/oil emulsion composition of claim 9, wherein the polymer in the oil phase comprises polycarbonate, polyethylenimine, polyetherimide, polybutadiene, or a mixture thereof.

18. The water/oil emulsion composition of claim 9, wherein the organic solvent comprises dichloromethane, chloroform, carbon tetrachloride, 1,2-dichloroethane, methyl-tert-butyl ether, a C5-C12 alkane, a C5-C8 cycloalkane, benzene, toluene or a xylene, or a mixture thereof.

19. (canceled)

20. The water/oil emulsion composition of claim 9, wherein the concentration of the polymer in the oil phase is from about 0.001 wt % to about 90 wt % of the oil phase.

21-27. (canceled)

28. A method of preparing a porous polymer nanocomposite comprising:
preparing the water/oil emulsion composition comprising a water phase and an oil phase,
wherein the water phase comprises nanoparticles suspended in water, and
the oil phase comprises a solution comprising a polymer and a water-immiscible organic solvent;
casting the water/oil emulsion composition on a substrate to form a film; and
drying the film to form the porous polymer nanocomposite.

29. The method of claim 28, further comprising preparing the water phase by a method comprising ultrasonication.

30. (canceled)

31. The method of claim 28, wherein the substrate is selected from nonconductive substrates, conductive substrate, and magnetic substrates.

32. (canceled)

33. The method of claim 28, wherein the thickness of the film is from about 1 μm to about 10 mm.

34. The method of claim 28, wherein the drying comprises evaporating the solvents at a temperature of from about 30° C. to about 100° C.

35. (canceled)
